(19) United States
(12) Patent Application Publication
(10) Pub. No.: US 2005/0284382 A1
(43) Pub. Date: Dec. 29, 2005

(54) METHOD AND APPARATUS FOR SELECTIVELY FEEDING ANIMALS

(76) Inventors: George Stantchev, Phoenix, AZ (US); Mariana Stantcheva, Phoenix, AZ (US)

Correspondence Address: George Stantchev, 15831 N 33rd Pl, Phoenix, AZ, 85032, US

(21) Appl. No.: 10/908,810

(22) Filed: May 26, 2005

Related U.S. Application Data
(60) Provisional application No. 60/575,071, filed on May 27, 2004.

(51) Int. Cl. A01K 5/02

(52) U.S. Cl. 119/51.02

(57) ABSTRACT

An apparatus that allows selectively feeding animals and corresponding method is disclosed. The apparatus includes in general a food container, dozer with a control unit and wireless identification and communication interfaces. In other aspects the invention is used to selectively feed animals by time, food quantity and species diversity.

### BACKGROUND OF INVENTION

The pet container especially when is located outdoor can be exposed to various weather conditions as rain, wind, hail that can damage or spill the food. Also there is a risk when more than one animal living together the food can be dedicated for each pet. Very often from the outdoor feeding the benefited animals are the wild or other than the residential.

The present patent application provides method and apparatus for recognizing and feeding pets especially when they are more than one kind living in the same area. The benefits of using the invention are dosing the food in shares, selectively feeding the dedicated animals, preserving the food from various weather conditions.

### SUMMARY OF INVENTION

The pet food container is placed above the pet pan. The food container can contain as many sections are necessary to perform its function. The container is equipped with a dosage device. The dosage device allows the food to be dosed in portions that can vary by the time of the day and the pet presence. It can be one or multiple dosage devices that will serve single or multiple food containers.

The pet is identified by its RFID tag when approaches the pan. The pet wears the RFID tag as neckpiece or by other appropriate way. The dozer unit is equipped with “color” identification and can be programmed to recognize each eligible pet. These way unauthorized pets will not be allowed to eat from the pan.

The RFID pet feeding system can be used to feed number of eligible animals by variety of food by the time of the day as well as preventing other animals to eat from the same container either for food dosage by kind or quality.

### BRIEF DESCRIPTION OF DRAWINGS

FIG. 10 shows the appropriate usage of the food container in presence of an animal.

FIG. 20 shows the architecture block diagram of the control logic necessary to operate the identification process and the function set of the container.

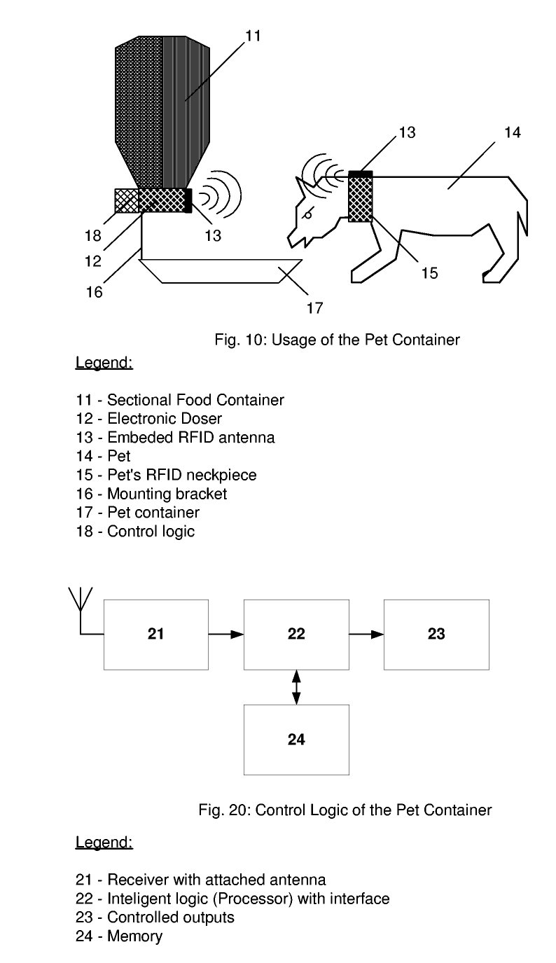

The detailed description of the drawings along with the functions of the pet container is given below.

### DETAILED DESCRIPTION

The food container (11) is placed on a mounting bracket (16) or mounted at appropriate location above the pet container (17). The food container (11) it self can serve only one kind or mix of food or can be sectioned as shown at the picture and contain different food kind as example by vitamins or by flavor. The dozer (12) allows certain kind of food to be served in an appropriate quantity when the pet approaches the pan. The dosage can be sectioned and allows more than one section of the container to be served. The dosage device (12) is controlled by intelligent logic (18) that enables the dosage device regarding a program. The program allows the feeding to occur by kind of pet or time of the day or quantity and variety of the food.

In order the dosage to allow serving, the pet needs to wear a neckpiece with appropriate attached electronic device that matches to the wireless interface of the dozer control unit. The interface can be either RFID, infrared or any other kind of radio waves.

The dozer (12) is controlled by controller device (18). The controller device is given at FIG. 20 and needs to accommodate the following components: a receiver (21), receiver processor (22), memory (24) and controlled outputs (23). Antenna (13) reads the pets identification and sends the information to the intelligent logic (processor unit). Regarding the preset data into the memory the processor decides on the kind and the quantity of the food. The controlled outputs trigger the dozer mechanism. Simple feedback can be included to monitor if the container is empty.

The controller device support simple interface to a PC based master device. The PC based device can be either personal computer, PDA or other remote terminal. The interface can be provided over one or number of protocols over wire as RS232, RS422, USB, LAN etc. or wireless as infrared, USB, Bluetooth, WLAN.

1. A pet container comprising food container, a dozer equipped with electronic doze control device and a pan located below the dozer.

2. A pet container according to claim 1 wherein the container and the dozer have multiple sections.

3. A pet container according to claim 1 wherein the dozer provides a feedback to the electronic device for the amount of the food in the pan.

4. A pet container according to claim 1 wherein the electronic device can be programmed distantly from another electronic device.

5. A pet container comprising food container, a dozer equipped with electronic doze control device, wireless identification device and a pan located below the dozer.

6. A pet container according to claim 5 wherein the container and the dozer have multiple sections.

7. A pet container according to claim 5 wherein the dozer provides a feedback to the electronic device for the amount of the food in the pan.

8. A pet container according to claim 5 wherein the electronic device can be programmed distantly from another electronic device.

9. A pet container comprising food container, a dozer equipped with electronic doze control device, wireless identification device matched to an electronic device carried by the pet and a pan located below the dozer.

10. A pet container according to claim 9 wherein the container and the dozer have multiple sections.

11. A pet container according to claim 9 wherein the wireless identification device supports multiple wirelessly matched devices carried by the pets.

12. A pet container according to claim 9 wherein the electronic dose device uses the feedback of the wireless identification device.

13. A pet container according to claim 9 wherein the dozer provides a feedback to the electronic device for the amount of the food in the pan.

14. A pet container according to claim 9 wherein the electronic device can be programmed distantly from another electronic device.
